(19) United States
(12) Patent Application Publication
(10) Pub. No.: US 2005/0188920 A1
(43) Pub. Date: Sep. 1, 2005

(54) Paste application apparatus and method

(75) Inventor: Noriaki Shimoda, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHIBAURA MECHATRONICS CORPORATION, Yokohama-shi (JP)

(21) Appl. No.: 10/786,544

(22) Filed: Feb. 26, 2004

(30) Foreign Application Priority Data
Feb. 28, 2003 (JP) 2003-053871

(51) Int. Cl. B05C 5/00; B05B 13/02

(52) U.S. Cl. 118/663; 118/305; 118/313

(57) ABSTRACT

A paste application apparatus including a Y-axis table, a Y-axis movement mechanism, a head mechanism main unit, and a syringe. The Y-axis movement table is configured to place a substrate thereon and to be capable of moving the substrate in a Y-axis direction. The Y-axis movement mechanism extends in the Y-axis direction. The head mechanism main unit extends in an X-axis direction and is moveable in the Y-axis direction by the Y-axis movement mechanism. The syringe is provided on the head mechanism main unit. The syringe is disposed above the substrate and is rendered movable in the X-axis direction. The application of paste contained in the syringe to a surface of the substrate is made by relative movement of the syringe and the substrate.

### BACKGROUND OF THE INVENTION

1. Field of the Invention

The present invention relates to improvements in a paste application apparatus and to a method for applying paste to a surface of a substrate.

2. Description of the Related Art

A liquid crystal display panel is manufactured by sticking two glass substrates together while sandwiching a liquid crystal member. To stick the two substrates together, adhesive paste is applied to a surface of one substrate opposing to a surface of the other substrate.

Paste is applied in such a way that a closed loop is drawn around a display surface to be formed on the substrate. For this purpose, a syringe discharging paste is disposed above the substrate, and a pattern of paste application is formed by performing relative movement of the syringe and the substrate at a position where a nozzle head of the syringe is opposed to the substrate while discharging paste from the nozzle head.

For applying paste to the surface of the substrate by means of the relative movement, the following methods are known among other things; one method is to apply paste with a fixed syringe containing paste while moving the substrate, disposed opposite to and below the syringe, in X-Y directions (Japanese Patent Application Laid-open Publication No. 5-15818). Another method is to apply paste to the fixed substrate through moving a syringe, disposed opposite to and above the substrate, in the X-Y directions (Japanese Patent Application Laid-open Publication No. 9-323056).

### SUMMARY OF THE INVENTION

With regard to a display surface to be formed on the substrate while being applied with paste, the following patterns are known among other things; one pattern is to form a single display surface on each substrate, and another method is to form a plurality of display surfaces of the same design on each substrate in a matrix. In particular, the latter pattern is often referred to as a multiple pattern, and the following description will also designate the latter pattern as a multiple pattern at the same time.

With regard to a substrate to be prepared with a multiple pattern, it is possible to form a plurality of display surfaces at the same time on a single substrate by pre-setting the corresponding number of syringes so as to accommodate the arrangement pitch in the multiple pattern.

FIG. 1 is a perspective view showing a paste application apparatus which is configured to set a plurality of syringes fixed so as to correspond to the arrangement pitch of a desired pattern for paste application, and to displace a substrate in X-Y directions.

In FIG. 1, an X-Y movement table 2 is placed on a base 1. A head mechanism 4 mounted with two syringes 41 and 42 is disposed above a substrate 3 placed on the X-Y movement table 2. The pair of syringes 41 and 42 are positioned and disposed so as to correspond to the arrangement pitch in an X-axis direction of a desired pattern for arranging display surfaces on the substrate 3 in order to draw and form two desired patterns at the same time. The X-Y movement table 2 and the head mechanism 4 mounted with the syringes 41 and 42 are respectively connected to a control unit 5. As the control unit 5 controls an entire paste application operation, paste discharged from the two syringes 41 and 42 at the same time is applied so as to draw two desired patterns at the same time by moving the substrate 3 in the X-Y directions with the X-Y movement table 2.

As illustrated therein, the syringes 41 and 42 of the head mechanism 4 are connected to Z-axis movement mechanisms 43 and 44, and are rendered capable of adjusting movement in a vertical (Z-axis) direction. CCD cameras (not illustrated) are respectively fitted to the syringes 41 and 42. Each of the CCD cameras fitted to the respective syringes 41 and 42 scans an alignment mark formed on the substrate 3 and supplies the scanned image of the alignment mark to the control unit 5. Accordingly, the control unit 5 can detect the position of the substrate 3 by pattern recognition based on the scanned images thus supplied, and can perform positioning control and the like of the substrate 3 for the paste application operation. Although the substrate 3 is placed on the X-Y movement table 2 in FIG. 1, it is also possible to perform positioning control of the placed substrate 3 in a θ (turning) direction by replacing this X-Y movement table 2 with an X-Y-θ movement table.

Moreover, although it is not illustrated in the drawing, a range finder utilizing a laser beam is connected to each of the syringes 41 and 42 to measure a height of the surface of the substrate 3, and the distance between the surface of the substrate and the nozzle head is thereby controlled to keep constant an amount of paste to be applied.

In this way, the control unit 5 performs positioning control of the substrate 3 in relation to the syringes 41 and 42 by controlling the drive of the X-Y movement table 2, then controls a respective amount and timing of discharging paste from each of the syringes 41 and 42, and controls the X-Y movement table 2 in accordance with a prescribed program to displace the substrate 3 in the X-Y directions. Accordingly, a desired pattern of paste application are drawn and formed on the surface of the substrate 3.

Here, a power circuit and the like are embedded in the base 1 mounted with the X-Y movement table 2, and a monitor display 6a and a keyboard 6b are connected to the control unit 5. Accordingly, an operator can control an operation of applying paste onto the substrate 3 through the keyboard 6b.

In the paste application apparatus shown in FIG. 1, the substrate 3 placed on the X-Y movement table 2 is moved in an X-Y plane in relation to the positioned and fixed syringes 41 and 42. However, Given that a pattern of paste application are formed by relative movement of the syringes 41 and 42 and the substrate 3, it is also conceivable that the same pattern of applying paste onto the surface of the substrate 3 is formed by fixing the substrate 3, and by mounting the syringes 41 and 42 containing paste therein on an X-Y movement mechanism.

Incidentally, the paste application apparatus is configured to dispose the syringe containing paste opposite to and above the substrate which is placed on the base, and to form a pattern of paste application either by moving the substrate in the X-Y directions with the syringe fixed at a desired position or by moving the syringe containing paste in the X-Y directions with the substrate fixed at a given position on the base.

As described above, the paste application apparatus is configured to draw the given pattern of paste application on the surface of the substrate by moving either the substrate or the syringe containing paste in the X-Y directions.

In the case of the former configuration of merely moving the substrate to be applied with paste in the X-Y directions relative to the fixed syringe, however, the larger substrates have been produced in response to the recent demand for enlarged substrates, the larger space has been required for production of such larger substrates. This is because such larger substrates need to be moved in a correspondingly larger extent in a horizontal direction to the X-Y directions. Accordingly, improvements in configuration have been awaited in light of space saving.

Given that a pattern of paste application to be actually employed are not always a multiple application pattern which needs a plurality of syringes to be disposed, the space occupied with a paste application apparatus accommodating a multiple application pattern is underused while a pattern other than a multiple application pattern is pursued. This causes a problem in light of effective utilization of a factory site.

On the contrary, with regard to the latter configuration of fixing a substrate onto the base and of moving the syringe in the X-Y directions, a syringe heavy with paste contained therein are mechanically moved above the substrate. However, metal dust is produced by abrasion and the like in portions of the kind of apparatus that displaces such a heavy load, and the fallen metal dust contaminates the surface of the substrate therebelow.

In addition, an X-Y movement mechanism to be moved while holding syringes needs to displace the heavy syringes widely and at high speed on the X-Y plane in the both X and Y directions. Accordingly, a durable structure is required to be constructed and the large power of inertia associated with conveyance and movement of the heavy load constitutes an impediment to efficiency of an application process.

Therefore, it is an object of the present invention to provide a paste application apparatus which is capable of preventing the apparatus as a whole from being enlarged in size in response to a range of movement on an X-Y plane which would otherwise be correspondingly larger, avoiding contaminating the surface of a substrate with fallen metal dust which would otherwise be produced, and improving efficiency in paste application.

To solve the aforementioned problems, a paste application apparatus according to the present invention includes: a base; a Y-axis movement table mounted on the base, the Y-axis movement table being configured to place a substrate thereon and capable of moving the substrate in a Y-axis direction; a Y-axis movement mechanism mounted on the base; a head mechanism main unit being movable in the Y-axis direction by the Y-axis movement mechanism; and a plurality of syringes provided on the head mechanism main unit, the syringe disposed above the substrate and being movable in an X-axis direction, the syringe containing paste, wherein an application of paste contained in the syringe to the surface of substrate is made by relative movement of both the syringe and the substrate.

In this way, the paste application apparatus according to the present invention is configured to place a substrate on the Y-axis movement table and to be capable of moving syringe containing paste in the Y-axis direction by the Y-axis movement mechanism. By this, the paste application apparatus can displace both syringe and a substrate in mutually opposite directions along the Y-axis direction. Accordingly, it is possible to substantially reduce the range (stroke) of moving a substrate in the Y-axis direction while performing paste application and formation, as compared to a case of moving only the substrate in the Y-axis direction.

Moreover, by the above-described configuration, it is possible to reduce the range of moving syringe in the Y-axis direction as short as possible. In this way, it is possible to reduce a mechanical load on the movement mechanism provided with syringe, to suppress production of metal dust caused by mechanical abrasions and the like, and to achieve a high-speed operation of paste application with high precision, as compared to a case of fixing the substrate in a given place while moving the syringe entirely in the Y-axis direction.

As described above, this paste application apparatus according to the present invention would be able to avoid preventing the occupancy area, required for the range of operating the apparatus, from becoming larger regardless of the current trend towards enlarged substrates, and, therefore, to achieve space saving. In this way, the paste application apparatus can exert an excellent effect upon practice.

### BRIEF DESCRIPTION OF THE DRAWINGS

FIG. 1 is a perspective view showing an example of a paste application apparatus.

FIG. 2 is a perspective view showing an embodiment of a paste application apparatus according to the present invention.

FIG. 3 is an enlarged plane view of the paste application apparatus shown in FIG. 2.

FIG. 4 is a block diagram showing the sequence of a control system of the paste application apparatus shown in FIG. 2.

### DETAILED DESCRIPTION OF THE PREFERRED EMBODIMENT

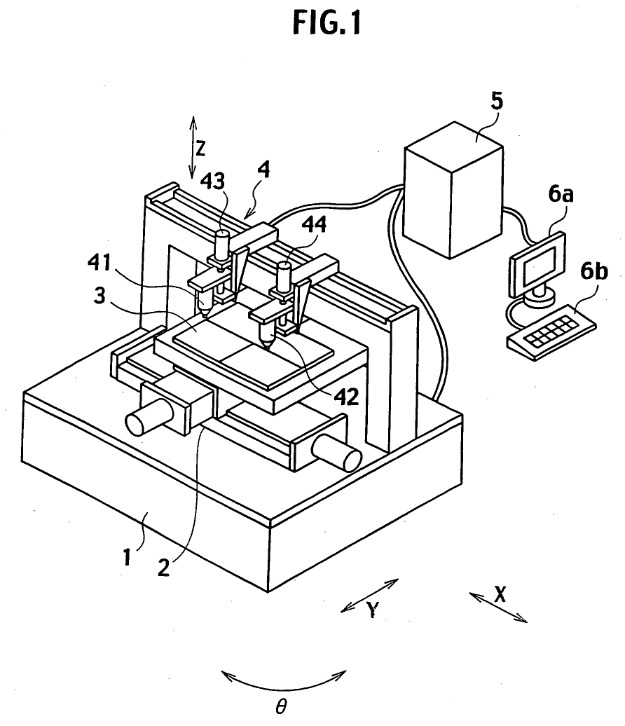

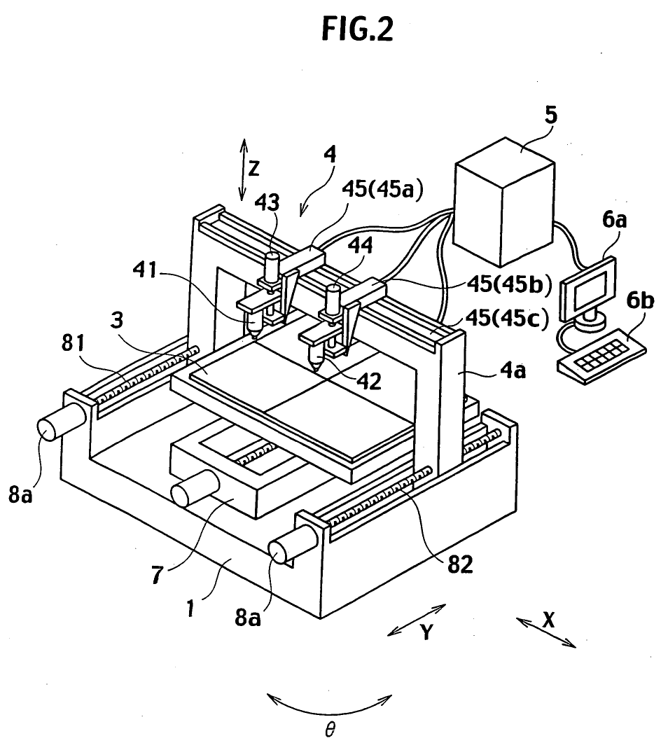

An embodiment of a paste application apparatus according to the present invention will be described in detail with reference to FIG. 2 to FIG. 4. Note that the same constituents as those in the paste application apparatus shown in FIG. 1 are designated with the same reference numerals and symbols, and detailed description will be omitted herein.

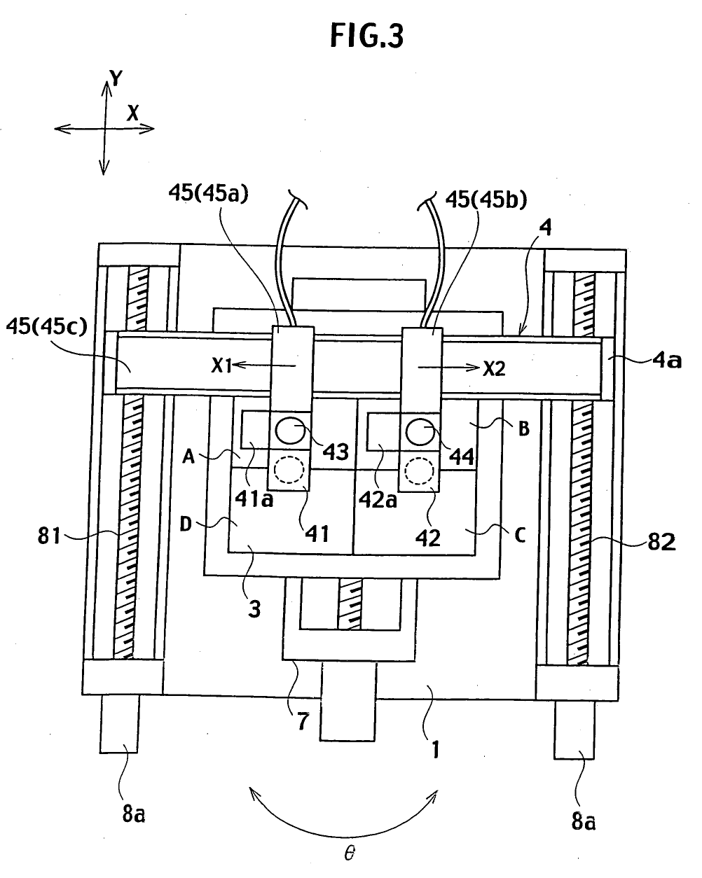

FIG. 2 is a perspective view of an embodiment of a paste application apparatus according to the present invention and FIG. 3 is a magnified plane view of the paste application apparatus shown in FIG. 2.

In FIG. 2, a Y-axis movement table 7 is disposed on a base 1, and a substrate 3 is positioned and placed on the Y-axis movement table 7.

In addition, on both outer sides in an upper portion of the base 1 sandwiching the Y-axis movement table 7 therebetween, Y-axis movement mechanisms 81 and 82 are provided side by side so as to extend the Y-axis as a longitudinal direction. Each of the Y-axis movement mechanisms 81 and 82 is comprised of a servo motor 8a and a feed screw mechanism driven by the servo motors 8a. A head mechanism 4 provided with syringes 41 and 42 is incorporated in the Y-axis movement mechanisms 81 and 82 so as to be movable in the Y-axis direction. Drive synchronized between the respective servo motors 8a of the Y-axis movement mechanisms 81 and 82 is controlled by a control unit 5.

As in the case of the configuration in FIG. 1, the syringes 41 and 42 are provided to the head mechanism 4 so that the syringes 41 and 42 can form two paste application patterns at the same time while referring to a desired multiple pattern with which the substrate is prepared. Drive of the respective syringes 41 and 42 in this embodiment is separately controlled by the control unit 5, and the syringes 41 and 42 are configured to be independently movable in the X-axis direction on a main unit 4a constituting a part of the head mechanism 4 which is formed into a portal.

Specifically, as shown in the plan view of FIG. 3, the syringes 41 and 42 are connected respectively to Z-axis movement mechanisms 43 and 44. Moreover, the Z-axis movement mechanisms 43 and 44 are connected respectively to primary moving parts 45a and 45b of an X-axis movement mechanism 45 including linear motors.

A secondary fixing part 45c of the X-axis movement mechanism 45 is provided on the main unit 4a of the head mechanism so that the direction of movement is parallel to the X-axis direction. Accordingly, the syringes 41 and 42 can move respectively in X1 and X2 directions as indicated by arrows in the drawing, or can move respectively in directions opposite to the X1 and X2 directions as indicated by the respective arrows, i.e. in mutually opposite directions on the X axis.

Here, a power circuit and the like are embedded in the base 1 mounted with the Y-axis movement table 7, and a monitor display 6a and a keyboard 6b are connected to the control unit 5. Accordingly, an operator can perform an operation of applying paste to the substrate 3 by manipulating the keyboard 6b.

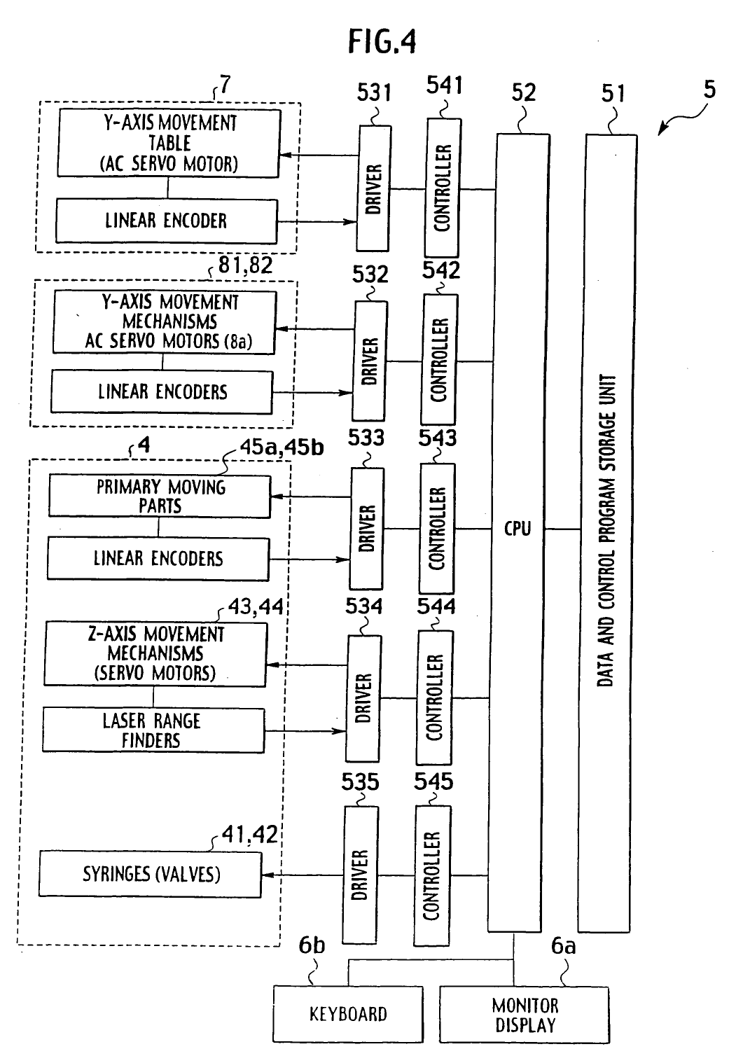

FIG. 4 is a block diagram for schematically describing a control system for the Y-axis movement table 7, the Y-axis movement mechanisms 81 and 82, and the head mechanism 4.

Specifically, the control unit 5 includes: a RAM and/or a ROM; a storage unit 51 storing application data and application control programs; a CPU 52 configured to read the data and the control program stored in this storage unit 51, to perform calculation based on an application condition inputted by the keyboard 6b or a touch panel on the monitor display 6a, and thereby to calculate control data for the Y-axis movement table 7, the Y-axis movement mechanisms 81 and 82, and the head mechanism 4; and controllers 541 to 545 configured to receive the control data calculated by this CPU 52, to generate individual control signals, and to be connected respectively to corresponding drivers 531 to 535 to supply the generated control signals.

The control system shown in FIG. 4 performs so-called dispenser control, i.e., control of the discharging of paste by adjusting valves of the syringes 41 and 42, and so-called gap control, i.e., control of the height of the nozzle head of each of the syringes 41 and 42 above the substrate by controlling the Z-axis movement mechanisms 43 and 44 based on measurement data from laser range finders, as in the case of the apparatus of FIG. 1.

The apparatus according to this embodiment is different from the apparatus of FIG. 1 in that the drivers receiving feedback signals from respective linear encoders control the drive of the Y-axis movement table 7, the Y-axis movement mechanisms 81 and 82, and the primary moving parts 45a and 45b of the head mechanism 4, and thereby form application tracks of the paste.

Specifically, paste application in the Y-axis direction is executed by the Y-axis movement table 7 and the Y-axis movement mechanisms 81 and 82. By this relative movement of the Y-axis movement table 7 and the Y-axis movement mechanisms 81 and 82, it is possible to reduce motion stroke in the Y-axis direction of the entire apparatus.

The motion in this event will be described below, citing an example of applying paste with the same pattern on each quarter of the surface of the substrate 3 shown in FIG. 3, and designating the quarters clockwise starting from a left top as A, B, C, and D.

Firstly, the syringes 41 and 42 are moved relative to the substrate 3 by controlling the Y-axis movement mechanisms 81 and 82 as well as the X-axis movement mechanism 45, and then the syringe 41 is positioned immediately above an application starting position of the application pattern for the region A and the syringe 42 is positioned immediately above an application starting position of the application pattern for the region B, respectively.

Here, the syringes 41 and 42 are brought down and are positioned so that distances between the nozzles of the syringes 41 and 42 and the substrate 3 are adjusted to prescribed application intervals by use of output signals from the laser range finders.

Next, the substrate 3 and the syringes 41 and 42 are moved by controlling the Y-axis movement table 7 and the X-axis movement mechanism 45 while discharging paste from the nozzles of the syringes 41 and 42, and paste is thereby applied to the regions A and B in desired application patterns. The discharge of paste is stopped at ending positions of the application patterns, and, at the same time, the movement of the substrate 3 and the syringes 41 and 42 by the Y-axis movement table 7 and the X-axis movement mechanism 45 is stopped, whereby the paste application to the regions A and B is finished. The syringes 41 and 42 after finishing the application are lifted up to a standby height.

Thereafter, the substrate 3 and the syringes 41 and 42 are respectively moved by controlling the Y-axis movement table 7, the Y-axis movement mechanisms 81 and 82, and the X-axis movement mechanism 45, and then the syringe 41 is positioned immediately above an application starting position of the application pattern for the region D and the syringe 42 is positioned immediately above an application starting position of the application pattern for the region C, respectively. Here, when the syringes 41 and 42 and the substrate 3 are moved relatively in the Y-axis direction so as to displace the syringe 41 from the region A to the region D and to displace the syringe 42 from the region B to the region C, the movement of the substrate 3 by the Y-axis movement table 7 and the movement of the syringes 41 and 42 by the Y-axis movement mechanisms 81 and 82 are executed in mutually opposite directions (in FIG. 3, the substrate 3 is moved upward and the syringes 41 and 42 are moved downward) at the same time. In this way, it is possible to relatively displace the syringes 41 and 42 and the substrate 3 at a speed produced through combination of the speed of the Y-axis movement table 7 and the speed of the Y-axis movement mechanisms 81 and 82. Accordingly, it is possible to displace the syringes 41 and 42 respectively to the starting positions of subsequent paste application in a shorter period of time, as compared to the case of moving either the syringes 41 and 42 or the substrate 3, and thereby to improve efficiency of the paste application operation.

Next, the substrate 3 and the syringes 41 and 42 are relatively moved by controlling the Y-axis movement table 7 and the X-axis movement mechanism 45 while discharging paste from the nozzles of the syringes 41 and 42, and the paste is thereby applied to the regions D and C in desired paste application patterns. The discharge of paste is stopped at ending positions of the paste application patterns, and the relative movement of the substrate 3 and the syringes 41 and 42 by the Y-axis movement table 7 and the X-axis movement mechanism 45 is stopped, whereby the application to the regions D and C is completed.

Meanwhile, paste application in the X-axis direction is executed by the primary moving parts of the head mechanism 45. Here, when primary moving parts 45a and 45b are provided as shown in FIG. 2 and FIG. 3, the force of inertia given by the application motion in the X-axis direction is offset by controlling the primary moving parts 45a and 45b so as to be moved in mutually opposite directions. In this way, it is possible to obtain the stable application motion.

Of input data from the keyboard 6b and the monitor display 6a, particularly, so-called NC data such as data representing a position of drawing to be started on coordinate and data for instruction of drawing sequence, data representing condition for determining drawing range and R (radius) at a corner with regard to a given application pattern, control data such as data for controlling the dispenser control or the gap control, data of drawing speed, and the like are inputted and established as in the case of the apparatus of FIG. 1.

However, the apparatus of this embodiment is different from the apparatus of FIG. 1 in that it is possible to displace the primary moving parts 45a and 45b in mutually opposite directions on the X axis in the course of application track control by instructing directions of movement (traveling) respectively for the primary moving parts 45a and 45b.

As described above, in the paste application apparatus according to this embodiment, the syringes 41 and 42 can move on the X axis independently of each other by being controlled by the control unit 5. By this, it is possible to draw two subsequent paste patterns at the same time by moving the syringes 41 and 42 in mutually opposite directions on the X axis after a plurality of preceding paste patterns have been formed. Since the syringes 41 and 42 draw paste patterns while moving on the X axis in mutually opposite directions, the force of inertia in the X-axis direction applied to the main unit 4a of the head mechanism 4 associated with the movement of the syringes 41 and 42 is offset. As a result, it is possible to reduce mechanical loads on the main unit 4a of the head mechanism 4 and connections between the head mechanism 4 and the respective Y-axis movement mechanisms 81 and 82 associated with the movement. Therefore, it is possible to reduce the weight of the head mechanism 4 and to suppress production of metal dust attributable to mechanical friction and the like.

Moreover, in the paste application apparatus according to this embodiment, whereas the substrate 3 is placed on the Y-axis movement table 7 and is moved in the Y-axis direction, the syringes 41 and 42 containing paste can be also moved similarly in the Y-axis direction by the movement of the head mechanism 4 by the Y-axis movement mechanisms 81 and 82. Accordingly, the substrate 3 and the syringes 41 and 42 can be moved in mutually opposite directions on the Y axis.

Therefore, it is possible to reduce, at least by half, a movement range (stroke) of the substrate 3 in the Y-axis direction when moving the syringes 41 and 42 from the respective ending positions of the application patterns to the respective starting positions of the subsequent application patterns, as compared to the case of moving only the substrate in the Y-axis direction.

Although the embodiment shows an example of incorporating the single head mechanism 4 in the pair of Y-axis movement mechanisms 81 and 82 on the right and left, it is also possible to incorporate a plurality of head mechanisms 4 so as to be provided side by side on the Y-axis movement mechanisms 81 and 82, and thereby to perform, more efficiently, paste application according to a multiple pattern in the Y-axis direction.

At the same time, although this embodiment describes an example of providing the syringes 41 and 42 on the single head mechanism 4, it is also possible to provide three or more syringes, and accordingly to perform efficient application of paste to the substrate 3 which is prepared with a multiple patterns in the X-axis direction.

Furthermore, this embodiment shows an example of adopting the feed screw mechanisms as the Y-axis movement mechanisms 81 and 82 and of adopting the linear motors for the movement of the syringes 41 and 42. However, it is possible to obtain a similar effect by employing, when deemed necessary, arbitrary movement mechanisms, as in the case of adopting linear motors for the Y-axis movement mechanisms 81 and 82 and adopting the feed screw mechanisms for movement of the syringes 41 and 42.

Note that illustrations of range finders to be fitted to the syringes 41 and 42 are omitted in FIG. 2 and FIG. 3. Reference numerals 41a and 42a as well as corresponding symbols denote CCD cameras which are respectively fitted to correspond to the syringes 41 and 42. The CCD cameras 41a and 42a supply scanned images of alignment marks on the substrate 3 to the control unit 5, and a positioning operation for paste application is performed by pattern recognition based on the scanned images of the alignment marks formed on the substrate 3 as in the case of the apparatus of FIG. 1.

Meanwhile, in this embodiment, some positioning adjustment in a 0 (turning) direction can also be added to the above-mentioned positioning adjustment by replacing the Y-axis movement table 7 with a Y-0 movement table.

As described above, the paste application apparatus according to this embodiment controls drive of the Y-axis movement table 7, the Y-axis movement mechanisms 81 and 82 as well as the head mechanism 4 through the control unit 5, and thereby controls correction of the position of the substrate 3 relative to the syringes 41 and 42 based on the images scanned by the CCD cameras 41a and 42a. Moreover, after the position correction, the amounts and timing of discharging the paste from each of the syringes 41 and 42, the Y-axis movement mechanisms 81 and 82, and the primary moving parts 45a and 45b of the X-axis movement mechanism 45 are controlled in accordance with the prescribed programs. In this way, it is possible to draw and form a given paste pattern by applying the paste discharged from the nozzle heads of the syringes 41 and 42 onto the surface of the substrate 3.

As described above, according to this embodiment, whereas the syringes 41 and 42 are moved in the X-Y direction, the substrate 3 disposed opposite is placed on the Y-axis movement table 7 and is moved in the Y-axis direction. Accordingly, it is possible to substantially reduce the movement range (stroke) of the substrate 3 in the Y-axis direction when additionally moving the syringes 41 and 42 from the ending positions of the application patterns to the starting positions of the subsequent application patterns as compared to the case of moving only the substrate in the Y-axis direction. In this way, it is possible to avoid an increase in size of the entire apparatus.

Moreover, as compared to the case of moving the syringes 41 and 42 in the X-Y directions while fixing the substrate 3, it is possible to reduce distance of movement of each of the syringes 41 and 42 in the Y-axis direction. In this way, it is possible to reduce the mechanical loads on the Y-axis movement mechanisms 81 and 82 attributable to movement of the head mechanism 4 in the Y-axis direction. Accordingly, production of metal dust attributable to abrasions and the like is suppressed as well, and it is possible to achieve formation of high-quality paste patterns while avoiding contamination of the substrate with metal dust.

Although this embodiment cites an example of relatively moving the syringes 41 and 42 and the substrate 3 to the relative movement by use of the Y-axis movement table 7 and the X-axis movement mechanism 45 while drawing of application patterns, it is also possible to use the Y-axis movement mechanisms 81 and 82 at the same time in addition to employing the Y-axis movement table 7 and the X-axis movement mechanism 45. In this case, if the substrate 3 and the syringes 41 and 42 are moved in mutually opposite directions at the same time by use of the Y-axis movement table 7 and the Y-axis movement mechanisms 81 and 82 in the case of achieving the movement in the Y-axis direction, it is possible to reduce the distance of movement by the respective movement devices (the Y-axis movement table 7 and the Y-axis movement mechanisms 81 and 82) as compared to the case of performing the relative movement of the substrate 3 and the syringes 41 and 42 in the Y direction by a single movement means. Moreover, if the speed of relative movement of the substrate 3 and the relative speed of movement of each of the syringes 41 and 42 are equal to each other, it is possible to reduce the speed of movement of the substrate 3 and the speed of movement of the head mechanism 4 including the syringes 41 and 42 by use of the respective movement devices, as compared to the case of performing the relative movement of the substrate 3 and the syringes 41 and 42 in the Y direction by a single movement means. As a result, it is possible to reduce the mechanical loads on the respective movement devices, to suppress generation of vibrations and the like attributable to the mechanical loads, and thereby to achieve the application operation with high precision and at high speed.

Moreover, this embodiment cites an example of applying paste patterns in closed loop. However, the shape of paste application patterns is not limited to the closed loop, and the present invention is also adoptable to application of application patterns which include open portions in some parts.

Furthermore, this embodiment cites an example of providing the Y-axis movement mechanisms 81 and 82 side by side on the both outer sides sandwiching the Y-axis movement table 7. However, the positions for disposing the Y-axis movement mechanisms 81 and 82 are not limited to the foregoing. For example, the Y-axis movement mechanism may be disposed on a support member which is horizontally disposed on the Y-axis movement table 7, and the head mechanism 4 may be incorporated in this Y-axis movement mechanism in a hanging manner so as to be freely movable in the Y-axis direction.

1. A paste application apparatus comprising:
a Y-axis movement table configured to place a substrate thereon and to be capable of moving the substrate in a Y-axis direction;
a Y-axis movement mechanism extending in the Y-axis direction;
a head mechanism main unit extending in an X-axis direction, the head mechanism main unit being movable in the Y-axis direction by the Y-axis movement mechanism; and
a syringe provided on the head mechanism main unit, the syringe being disposed above the substrate and rendered movable in the X-axis direction, the syringe containing paste,
wherein an application of paste contained in the syringe to a surface of the substrate is made by relative movement of the syringe and the substrate.

2. The paste application apparatus according to claim 1,
wherein a pair of the Y-axis movement mechanisms are provided on both sides of the Y-axis movement table, and
the head mechanism main unit is placed on the pair of the Y-axis movement mechanisms, the head mechanism main unit being formed so as to straddle the Y-axis movement table.

3. The paste application apparatus according to claim 1,
wherein a plurality of the syringes are provided on the head mechanism main unit.

4. The paste application apparatus according to claim 3,
wherein the plurality of the syringes are configured so as to be capable of applying paste to the substrate while moving independently of each other.

5. The paste application apparatus according to claim 4,
wherein the plurality of the syringes are configured so as to be capable of applying paste to the substrate at the same time while moving in mutually opposite directions on an X axis.

6. The paste application apparatus according to claim 1,
wherein a plurality of the head mechanism main units are placed on the Y-axis movement mechanism, and
each of the head mechanism main units is provided with the syringe respectively.

7. A paste application method comprising:
preparing a paste application apparatus, the paste application apparatus including a Y-axis movement table configured to place a substrate thereon and to be capable of moving the substrate in a Y-axis direction, a Y-axis movement mechanism extending in the Y-axis direction, a head mechanism main unit extending in an X-axis direction, the head mechanism main unit being movable in the Y-axis direction by the Y-axis movement mechanism, and a syringe provided on the head mechanism main unit, the syringe being disposed above the substrate and rendered movable in the X-axis direction, the syringe containing paste, the paste application apparatus being configured to apply paste contained in the syringe to a surface of the substrate by relative movement of the syringe and the substrate;
performing the relative movement of the substrate and the syringe in the Y-axis direction while forming an application pattern by use of the Y-axis movement table; and
performing the relative movement of the substrate and the syringe in the Y-axis direction while moving the syringe from an ending position of an application pattern to an starting position of a subsequent application pattern by moving the substrate and the syringe in mutually opposite directions by use of the Y-axis movement table and the Y-axis movement mechanism.

8. A paste application method comprising:
preparing a paste application apparatus, the paste application apparatus including a Y-axis movement table configured to place a substrate thereon and to be capable of moving the substrate in a Y-axis direction, a Y-axis movement mechanism extending in the Y-axis direction, a head mechanism main unit extending in an X-axis direction, the head mechanism main unit being movable in the Y-axis direction by the Y-axis movement mechanism, and a syringe provided on the head mechanism main unit, the syringe being disposed above the substrate and rendered movable in the X-axis direction, the syringe containing paste, the paste application apparatus being configured to apply the paste contained in the syringe to a surface of the substrate by relative movement of the syringe and the substrate; and
performing the relative movement of the substrate and the syringe in the Y-axis direction by moving the substrate and the syringe in mutually opposite directions by use of the Y-axis movement table and the Y-axis movement mechanism.
